(19) United States
(12) Patent Application Publication
(10) Pub. No.: US 2024/0322991 A1
(43) Pub. Date: Sep. 26, 2024

(54) MULTI-CARRIER NONLINEAR SELF-INTERFERENCE CANCELLATION FOR FULL-DUPLEX COMMUNICATION

(71) Applicant: QUALCOMM Incorporated, San Diego, CA (US)

(72) Inventors: Min Soo Sim, San Diego, CA (US); Shubham Ahuja, San Diego, CA (US); Wooseok Nam, San Diego, CA (US); Alexander Dorosenco, El Cajon, CA (US); Tao Luo, San Diego, CA (US)

(21) Appl. No.: 18/190,043

(22) Filed: Mar. 24, 2023

(51) Int. Cl. H04L 5/14; H04L 5/00

(52) U.S. Cl. CPC H04L 5/1461; H04L 5/001

(57) ABSTRACT

Methods, systems, and devices for wireless communications are described. A wireless communications device (e.g., a user equipment (UE) and/or a network entity) operating in a full-duplex operation mode may decode received signaling based on cancelling interference from transmitted signaling with a NLIC model with inter-component carrier (CC) terms. The wireless communications device may transmit and receive signaling using overlapping time resources in the full-duplex operation mode, which may cause self-interference (SI) due to the transmitted signaling interfering with the received signaling. Thus, the wireless communication device may implement a NLIC model to reduce, or remove, the SI on a per-CC basis, while accounting for inter-CC terms. That is, the NLIC model may include inter-CC terms, or kernels, that correspond to respective CCs of the transmitted signal.

### FIELD OF TECHNOLOGY

The following relates to wireless communications, including multi-carrier nonlinear self-interference cancellation (NLIC) for full-duplex communication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support multi-carrier nonlinear self-interference cancellation (NLIC) for full-duplex communication. For example, the described techniques provide for a wireless communications device (e.g., a user equipment (UE) and/or a network entity) operating in a full-duplex operation mode to decode received signaling based on cancelling interference from transmitted signaling with a NLIC model with inter-component carrier (CC) terms. The wireless communications device may transmit and receive signaling using overlapping time resources in the full-duplex operation mode, which may cause self-interference (SI) due to the transmitted signaling interfering with the received signaling. Thus, the wireless communication device may implement a NLIC model to reduce, or remove, the SI on a per-CC basis, while accounting for inter-CC terms. That is, the NLIC model may include inter-CC terms, or kernels, that correspond to respective CCs of the transmitted signal.

A method for wireless communication at a wireless communications device is described. The method may include transmitting, in accordance with a full-duplex operation mode at the wireless communications device, one or more first signals using a first set of multiple time resources, the one or more first signals associated with a set of multiple CCs, receiving, using a second set of multiple time resources that at least partially overlap with the first set of multiple time resources, a second signal associated with an interference value corresponding to the one or more first signals, and decoding the second signal based on cancelling the interference value in accordance with an NLIC model including one or more first inter-CC terms corresponding to respective CCs of the set of multiple CCs.

An apparatus for wireless communication at a wireless communications device is described. The apparatus may include a processor, and a memory coupled with the processor, with instructions stored in the memory. The instructions may be executable by the processor to cause the apparatus to transmit, in accordance with a full-duplex operation mode at the wireless communications device, one or more first signals using a first set of multiple time resources, the one or more first signals associated with a set of multiple CCs, receive, using a second set of multiple time resources that at least partially overlap with the first set of multiple time resources, a second signal associated with an interference value corresponding to the one or more first signals, and decode the second signal based on cancelling the interference value in accordance with an NLIC model including one or more first inter-CC terms corresponding to respective CCs of the set of multiple CCs.

Another apparatus for wireless communication at a wireless communications device is described. The apparatus may include means for transmitting, in accordance with a full-duplex operation mode at the wireless communications device, one or more first signals using a first set of multiple time resources, the one or more first signals associated with a set of multiple CCs, means for receiving, using a second set of multiple time resources that at least partially overlap with the first set of multiple time resources, a second signal associated with an interference value corresponding to the one or more first signals, and means for decoding the second signal based on cancelling the interference value in accordance with an NLIC model including one or more first inter-CC terms corresponding to respective CCs of the set of multiple CCs.

A non-transitory computer-readable medium storing code for wireless communication at a wireless communications device is described. The code may include instructions executable by a processor to transmit, in accordance with a full-duplex operation mode at the wireless communications device, one or more first signals using a first set of multiple time resources, the one or more first signals associated with a set of multiple CCs, receive, using a second set of multiple time resources that at least partially overlap with the first set of multiple time resources, a second signal associated with an interference value corresponding to the one or more first signals, and decode the second signal based on cancelling the interference value in accordance with an NLIC model including one or more first inter-CC terms corresponding to respective CCs of the set of multiple CCs.

Some examples of the method, apparatuses, and non-transitory computer-readable medium described herein may further include operations, features, means, or instructions for determining, for each CC of the set of multiple CCs, respective inter-CC terms and selecting, based on comparing the respective inter-CC terms to one or more threshold values, the one or more first inter-CC terms.

Some examples of the method, apparatuses, and non-transitory computer-readable medium described herein may further include operations, features, means, or instructions for determining a quantity of inter-CC terms to select based on an intermodulation distortion (IMD)-to-noise ratio for each CC of the set of multiple CCs.

In some examples of the method, apparatuses, and non-transitory computer-readable medium described herein, cancelling the interference value may include operations, features, means, or instructions for performing coefficient estimation to obtain one or more first coefficients for the one or more first inter-CC terms and generating, using the NLIC model, a SI reconstruction based on the one or more first coefficients, where cancelling the interference value includes subtracting the SI reconstruction from the second signal.

In some examples of the method, apparatuses, and non-transitory computer-readable medium described herein, the one or more first inter-CC terms may be stored at a buffer of the wireless communications device and the method, apparatuses, and non-transitory computer-readable medium may include further operations, features, means, or instructions for receiving, at the buffer of the wireless communications device and based on a timer expiring, information corresponding to one or more second inter-CC terms and performing the coefficient estimation to obtain one or more second coefficients for the one or more second inter-CC terms, where the wireless communications device cancels the interference value in accordance with the one or more second coefficients.

Some examples of the method, apparatuses, and non-transitory computer-readable medium described herein may further include operations, features, means, or instructions for obtaining the one or more first inter-CC terms based on performing channel estimation using the one or more first signals.

In some examples of the method, apparatuses, and non-transitory computer-readable medium described herein, the one or more first inter-CC terms include one or more IMD values corresponding to the respective CCs, a gain corresponding to the respective CCs, one or more delay values corresponding to the respective CCs, or any combination thereof.

In some examples of the method, apparatuses, and non-transitory computer-readable medium described herein, cancelling the interference value may include operations, features, means, or instructions for performing, for each CC of the respective CCs, SI cancellation (SIC) for the one or more first signals using the one or more first inter-CC terms.

In some examples of the method, apparatuses, and non-transitory computer-readable medium described herein, the second signal may be associated with one or more CCs.

### BRIEF DESCRIPTION OF THE DRAWINGS

FIGS. 1 and 2 show examples of wireless communications systems that support multi-carrier nonlinear self-interference cancellation (NLIC) for full-duplex communication in accordance with one or more aspects of the present disclosure.

FIGS. 3 and 4 show examples of interference cancellation diagrams that support multi-carrier NLIC for full-duplex communication in accordance with one or more aspects of the present disclosure.

FIG. 5 shows an example of a process flow that supports multi-carrier NLIC for full-duplex communication in accordance with one or more aspects of the present disclosure.

FIGS. 6 and 7 show block diagrams of devices that support multi-carrier NLIC for full-duplex communication in accordance with one or more aspects of the present disclosure.

FIG. 8 shows a block diagram of a communications manager that supports multi-carrier NLIC for full-duplex communication in accordance with one or more aspects of the present disclosure.

FIG. 9 shows a diagram of a system including a device that supports multi-carrier NLIC for full-duplex communication in accordance with one or more aspects of the present disclosure.

FIGS. 10 through 12 show flowcharts illustrating methods that support multi-carrier NLIC for full-duplex communication in accordance with one or more aspects of the present disclosure.

### DETAILED DESCRIPTION

In some wireless communications systems, wireless communications devices may communicate in a full duplex mode, in which the devices simultaneously transmit and receive signaling. However, with simultaneous transmission and reception, the transmitted signal may interfere with the received signal, or vice-versa, which may be referred to as self-interference (SI). Thus, a wireless communications device may implement SI cancellation (SIC) to cancel the interference and improve decodability of the received signal. Additionally, or alternatively, the wireless communication device may use a nonlinear SIC (NLIC) model to account for distortions such as power amplifier (PA) nonlinearity and phase noise. In some cases, such as for carrier aggregated (CA) signals, it may be difficult for the wireless communications device to process NLIC due to hardware and software processing capabilities of the wireless communications device. Thus, CA signals may be processed per-carrier rather than as a CA signal, which may cause NLIC performance degradation due to processing IMD terms between the carriers. The IMD terms may be the amplitude modulation of signals that include two or more different frequencies, caused by nonlinearities or time variance in a system. That is, the wireless communications devices may be unable to capture and cancel inter-component carrier (CC) IMD, as there may not be information of the other CCs in the CA signal.

As described herein, a wireless communications device may transmit and receive signals concurrently (e.g., using resources that overlap in the time domain), where the wireless communications device transmits the signal using multiple CCs. The wireless communications device may determine inter-CC parameters for respective CCs and may perform interference cancellation (e.g., NLIC) to cancel an interference component of the received signal that may be caused by the transmitted signal. For example, the wireless communications device may use the inter-CC terms (e.g., an IMD value, an IMD-to-noise ratio, a delay term, or the like), for respective CCs to cancel the interference component of the received signal.

Aspects of the disclosure are initially described in the context of wireless communications systems. Additional aspects of the disclosure are described herein with reference to interference cancellation diagrams and process flows. Aspects of the disclosure are further illustrated by and described herein with reference to apparatus diagrams, system diagrams, and flowcharts that relate to multi-carrier NLIC for full-duplex communication.

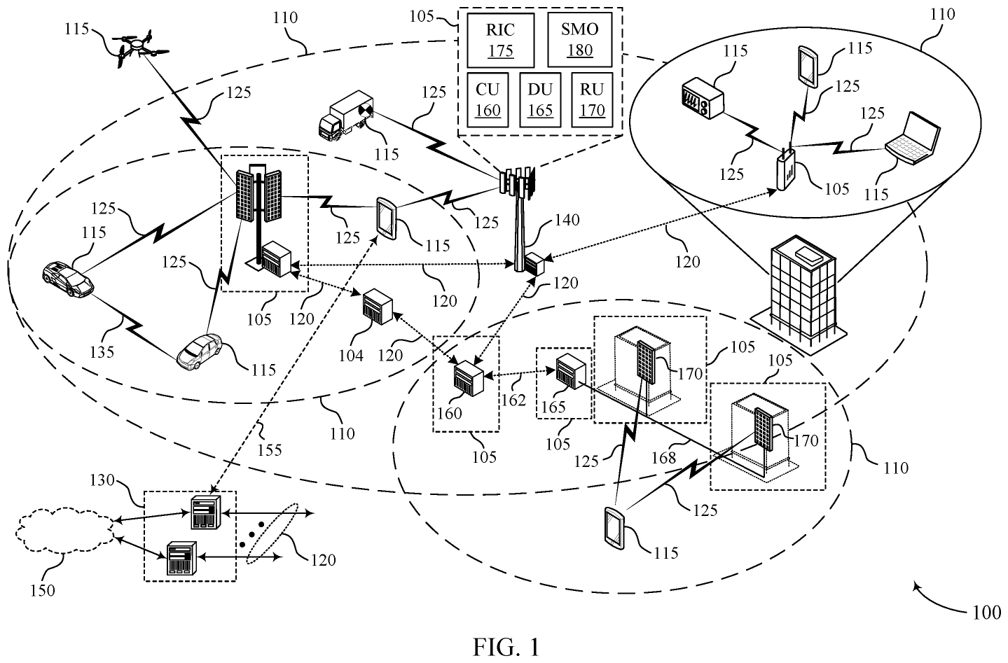

FIG. 1 shows an example of a wireless communications system 100 that supports multi-carrier NLIC for full-duplex communication in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support multi-carrier NLIC for full-duplex communication as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described herein with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In the wireless communications system 100, one or more wireless communications devices (e.g., UEs 115 and/or network entities 105) may communicate in a full duplex mode, in which the devices simultaneously transmit and receive signaling. However, with simultaneous transmission and reception, the transmitted signal may interfere with the received signal, or vice-versa, which may be referred to as SI. Thus, a wireless communications device may implement SIC to cancel the interference and improve decodability of the received signal. Additionally, or alternatively, the wireless communication device may use a nonlinear NLIC model to account for distortions such as PA nonlinearity and phase noise. In some cases, such as for CA signals, it may be difficult for the wireless communications device to process NLIC due to hardware and software processing capabilities of the wireless communications device. Thus, CA signals may be processed per-carrier rather than as a CA signal, which may cause NLIC performance degradation due to processing IMD terms between the carriers. The IMD terms may be the amplitude modulation of signals that include two or more different frequencies, caused by nonlinearities or time variance in a system. That is, the wireless communications devices may be unable to capture and cancel inter-CC IMD, as there may not be information of the other CCs in the CA signal.

In some examples, a wireless communications device may transmit and receive signals concurrently (e.g., using resources that overlap in the time domain), where the wireless communications device transmits the signal using multiple CCs. The wireless communications device may determine inter-CC parameters for respective CCs and may perform interference cancellation (e.g., NLIC) to cancel an interference component of the received signal that may be caused by the transmitted signal. For example, the wireless communications device may use one or more intra-CC terms and the inter-CC terms (e.g., an IMD value, an IMD-to-noise ratio, a delay term, or the like), for respective CCs to cancel the interference component of the received signal.

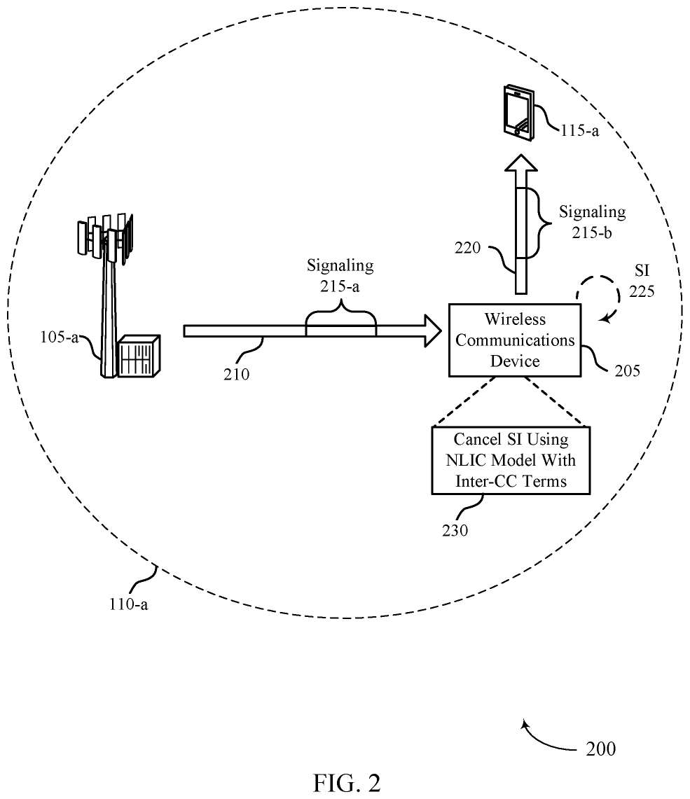

FIG. 2 shows an example of a wireless communications system 200 that supports multi-carrier NLIC for full-duplex communication in accordance with one or more aspects of the present disclosure. In some examples, the wireless communication system 200 may implement or be implemented by aspects of the wireless communication system 100 described herein with reference to FIG. 1. For example, the wireless communications system 200 may include a UE 115-b and a network entity 105-a with a coverage area 110-a, which may represent examples of corresponding devices described herein. Similarly, the wireless communications system 200 may include a wireless communications device 205 which may be an example of a UE 115 or a network entity 105 as described herein with reference to FIG. 1.

In some cases, the operations performed by the network entity 105-a may additionally, or alternatively, be performed by a UE. Similarly, the operations performed by the UE 115-a may additionally, or alternatively, be performed by a network entity. For example, the wireless communications device 205 may be a network entity, and may communicate with multiple UEs, multiple network entities, or both (e.g., where the operations performed by the network entity 105-a may alternatively be performed by a UE and/or the operations performed by the UE 115-a may alternatively be performed by a network entity). In some other examples, the wireless communications device 205 may be a UE, and may communicate with multiple network entities, multiple other UEs, or both.

The wireless communications device 205 may communicate and exchange signaling with the network entity 105-a, such as by using a downlink communication link 210 to receive control information, data, or both via signaling 215-a. Similarly, the wireless communications device 205 may communicate and exchange signaling with the UE 115-a, such as by using an uplink communication link 220 to transmit control information, data, or both via signaling 215-b. In some examples, the downlink communication link 210 and the uplink communication link 220 may be an example of Uu links, sidelinks, backhaul links, or some other type of communication links.

In some aspects, the wireless communications device 205 may be capable of full-duplex communication. Full-duplex communication may include a contemporaneous uplink and downlink communication using the same, or overlapping, time resources. In some aspects, the uplink and downlink communications may use a same frequency and/or overlapping frequency. In some aspects, the wireless communications device 205 may transmit in one sub-band and receive in another sub-band. For example, the wireless communications device 205 may perform a downlink transmission including the signaling 215-b to the UE 115-a and may receive an uplink transmission including the signaling 215-a from the network entity 105-a using the same and/or overlapping frequency resources, the same and/or overlapping time resources, or both. In some cases, the wireless communications device 205 may transmit or receive the signaling 215-a, the signaling 215-b, or both using multiple frequency blocks (e.g., CCs) using carrier aggregation (CA).

In some cases, the downlink transmission from the wireless communications device 205 may interfere with the uplink transmission to the wireless communications device 205, which may be referred to as SI 225. The SI 225 may be caused by a variety of factors, such as the higher transmit power for the downlink transmission as compared to the uplink transmission and/or radio frequency bleeding. For example, the self-interference may include direct interference from a transmission chain to a reception chain through an internal coupling path. In some aspects, self-interference may result from radio clutter, which may include over-the-air interference caused by objects surrounding the wireless communications device 205. The SI 225 may cause decoding errors for the signaling 215-a at the wireless communications device 205, which may lead to increased latency and signaling overhead due to unsuccessful decoding and retransmissions.

To mitigate, or reduce, the effects of the SI 225, the wireless communications device 205 may implement a SIC procedure. The SIC procedure may include analog SIC in which interference for an analog signal is canceled prior to applying a low-noise amplifier (LNA) by extracting an analog portion of the signaling 215-a after applying a power amplifier (PA). After analog SIC, an output signal passes through the LNA for digital SIC. For digital SIC, the wireless communications device 205 performs SI estimation using an SI model, and then reconstructs the SI signal to remove from the signaling 215-a.

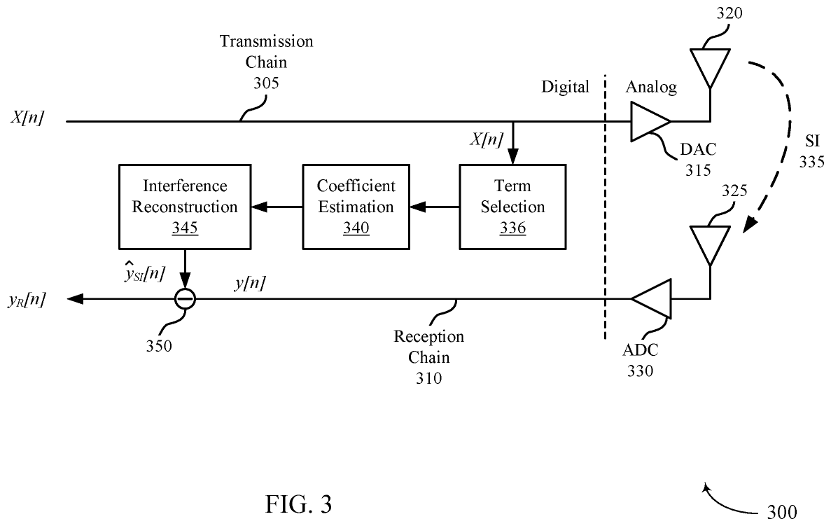

In some cases, the analog SIC and digital SIC techniques may not account for distortions in the signaling 215-a, such as PA nonlinearity and phase noise. Accordingly, the wireless communications device 205 may implement NLIC to facilitate the SIC. In some cases, NLIC may be performed using a nonlinear model, such as a Volterra-series model and/or a parallel Hammerstein (PH) model, among other examples. In some cases, to implement a nonlinear model, the wireless communications device 205 can estimate one or more coefficients of the model. Nonlinear models may include a quantity of nonlinear terms, which may be referred to as kernels. The quantity of coefficients may be the same as the quantity of nonlinear kernels. In some aspects, a network node (e.g., the wireless communications device 205) may select a subset of the nonlinear kernels to be used for SIC and may estimate a quantity of coefficients corresponding to the subset of nonlinear kernels, which is described in further detail with respect to FIG. 3.

However, for CA signals, it may be difficult to process NLIC due to hardware and software capabilities of the wireless communications device 205. In some cases, a wireless communications device 205 may perform full-band NLIC for the CA signals, which includes processing the CA signals together. Processing the CA signals together may provide for the wireless communications device 205 to cancel inter-CC IMD, but may have a relatively high processing rate. In some other cases, a wireless communications device 205 may perform per-CC NLIC for the CA signals, which includes processing each CC received signal separately. Thus, the wireless communications device 205 may use information of each transmitted signal of a corresponding CC. Processing each CC separately may reduce the processing rate, but may not capture and cancel inter-CC IMD, since there may not be information shared across CCs. This leads to NLIC performance degradation because IMD terms created between the carriers may not be generated in per-carrier NLIC methods which have no knowledge of other CCs.

In some examples, at 230, the wireless communications device 205 may perform SIC using a NLIC model with inter-CC terms to cancel inter-CC IMD while reducing the processing rate for multi-carrier NLIC. The wireless communications device 205 may share information of the NLIC model terms between the CCs, and may use that information to create inter-CC terms. Thus, the SI 225 may be canceled for CA at a per-CC signal rate rather than at a CA signal rate, which enables the use of low digital signal processing units while improving performance for processing the desired signal.

In some cases, the wireless communications device 205 may process the signaling 215-a per CC, but may use inter-CC terms (e.g., kernels) in the NLIC model. The wireless communications device may obtain transmit signal information (e.g., information for the signaling 215-b) from other CCs via a buffer. The transmit signal information may include the signal itself, a duration of the signal, reference signal information, or any combination thereof. The wireless communications device 205 may determine how many and which inter-CC terms to use, such as based on an IMD-to-noise ratio for each CC. Then, the wireless communications device 205 may estimate the coefficients of the inter-CC terms using the signaling 215-b via the buffer and the signaling 215-a, where the coefficients may include a gain and delay for the inter-CC terms. The wireless communications device 205 may store the coefficients in the buffer and reconstruct the inter-CC terms. At a later time (e.g., a later slot or any other time duration), the wireless communications device 205 may store the signaling 215-b in the buffer and may use the coefficients in the buffer to generate inter-CC terms for the later time. To cancel the SI 225, the wireless communications device 205 may subtract the reconstructed inter-CC parameters from the signaling 215-a of the later time.

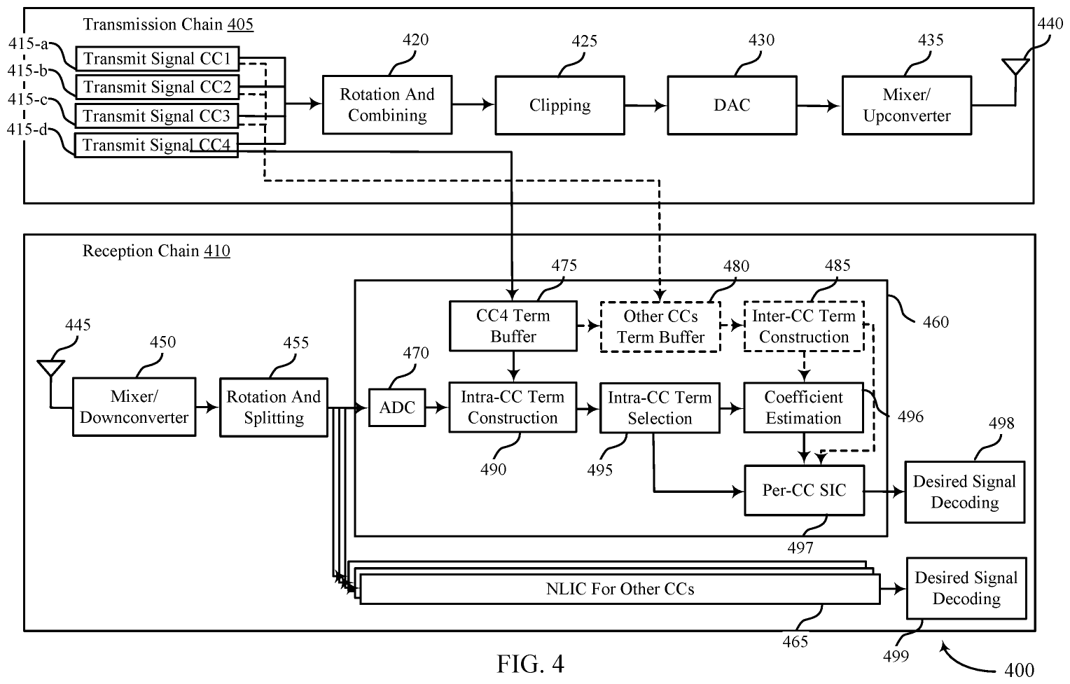

The inter-CC term reconstruction may be described in further detail with respect to FIG. 3 and FIG. 4. When constructing, or reconstructing, the inter-CC terms, the wireless communications device 205 may consider a power of the IMD terms with a jammer-to-noise ratio (JNR) and adjacent channel leakage ratio (ACLR). For example, if the IMD-to-noise ratio is high, more inter-CC terms may be considered, where a relatively high JNR or ACLR may lead to a relatively high IMD-to-noise ratio. Thus, the quantity of inter-CC terms may increase with a relatively high IMD-to-noise ratio. For frequency-selective channels, the inter-CC terms may include delay values.

FIG. 3 shows an example of an interference cancellation diagram 300 that supports multi-carrier NLIC for full-duplex communication in accordance with one or more aspects of the present disclosure. In some examples, the interference cancellation diagram 300 may implement or be implemented by the wireless communications system 100 and/or the wireless communications system 200. For example, the interference cancellation diagram 300 may illustrate inter-CC term selection for NLIC of a CA signal and may be implemented by a wireless communications device (e.g., a wireless communications device 205 as described herein with reference to FIG. 2).

In some cases, the wireless communications device may concurrently transmit and receive signaling in a full-duplex communication mode, where the transmitted signaling is sent via multiple CCs. The process of the wireless communications device receiving the signaling may include obtaining the signaling via one or more antenna elements, demodulating the signaling, decoding the signaling, converting the signaling from an analog domain to a digital domain, and/or determining a content of a communication included in the signaling, among other examples. Concurrently transmitting and receiving signaling using same or overlapping time resources may cause SI at the wireless communications device. In some aspects, the wireless communications device may cancel the SI from the CA signal using an NLIC model with one or more inter-CC terms, which the wireless communications device may select.

In some cases, the wireless communications device may implement a transmission chain 305 for transmitting signaling and a reception chain 310 for receiving signaling. The transmission chain 305 may include transmission of a signal, x[n], and the reception chain 310 may include reception of a signal, y[n]. In some cases, the transmission chain 305 may include a digital-to-analog converter (DAC) 315 that converts the signal, x[n], from the digital domain to the analog domain. In the analog domain, the wireless communications device may transmit the converted signal, x[n], using an antenna 320. As shown, the reception chain 310 may include an antenna 325 configured to receive the signal y[n] and an analog-to-digital converter (ADC) 330 configured to convert the received signal from the analog domain to the digital domain. The received signal y[n] may include control information and/or data, which may include interference from each of the CCs of the transmitted signal (e.g., SI 335). The wireless communications device may cancel the SI using a NLIC model that accounts for inter-CC terms. In some aspects, the NLIC model may include, for example, a polynomial SI model, a Volterra-series model, and/or a PH model.

In some cases, the polynomial SI model may be represented by Equation 1:

$$y [ n ] = {\sum }_{h , p , ℓ} {c}_{h , p , ℓ} {ψ}_{h , p , ℓ} ( x [ n ] ) , \qquad ( 1 )$$

where [symbol] (x[n]) are polynomial terms expressed as [symbol] (x[n])=x[n− [symbol] ]^{h}|x[n− [symbol] ]|^{p}, [symbol] is a delay, h and p are an order, x[n] is the transmitted signal, and y [n] is the receive signal with residual SI 335 after isolation and/or analog SIC.

In some examples, the wireless communications device may select one or more of the inter-CC terms from the NLIC model. For example, at 336, the wireless communications device may compare terms (e.g., inter-CC terms, intra-CC terms, or both) to one or more threshold values, and may select a quantity of terms based on the results of the comparison. Specifically, the quantity of terms may be directly proportional to an IMD-to-noise ratio for each CC. The wireless communications device may generate the selected terms. In some cases, the wireless communications device may determine (e.g., be configured with or otherwise obtain) one or more parameters to facilitate reducing computational complexity for the NLIC. For example, the one or more parameters may include a set of candidate nonlinear terms, a quantity of terms, and/or a duration of the reference signal.

In some cases, the wireless communications device may perform the inter-CC term selection process iteratively. For example, after selecting a quantity of terms (e.g., n−1, where n is the quantity of terms that have already been selected), the wireless communications device may orthonormalize each remaining term candidate to the selected terms. For example, the wireless communications device may select the n-th terms associated with the maximum correlation with the received signal. In some aspects, for example, the terms may be defined as [symbol] (x[n]). Any other term model may be used in accordance with the present disclosure.

In some examples, the wireless communications device may generate a set of all possible term candidates, K₀, using (h, p, l), where h, p, and l. are parameters used in the term selection process. For example, if 1≤h≤3, 0≤p≤6, and −21≤l≤21 there may be a total of 861 term candidates. Then, for 1≤n≤N, where N is the quantity of terms to be selected (e.g., the wireless communications device may select 11 terms), and for a term with index, c, in a set of term candidates left in Kₙ₋₁ (e.g., here the size of Kₙ₋₁ is 861−(n−1)), the wireless communications device may create the term vector for the c-th term using input signal, xᵢₙ, according to Equation 2:

$${s}_{c} = {ψ}_{{h}_{c} , {p}_{c} , {l}_{c}} ( {x}_{i n} [ n ] ) = {{x}_{i n} [ n - {l}_{c} ]}^{{h}_{c}} {\vert {x}_{i n} [ n - {l}_{c} ] \vert}^{{p}_{c}} . \qquad ( 2 )$$

The wireless communications device may then orthonormalize the term vector, s_{c}, with the orthonormalized term vectors S̅_{ortho[1:n-1]} of the previously selected n−1 terms according to Equation 3:

$${s}_{o r t h o , c} = {s}_{c} - {\overline{S}}_{o r t h o [ 1 : n - 1 ]} ( {( {\overline{S}}_{o r t h o [ 1 : n - 1 ]} )}^{H} {s}_{c} ) , \qquad ( 3 )$$

where

$${\overline{s}}_{o r t h o , c} = \frac{{s}_{o r t ho , c}}{‖ {s}_{o r t h o , c} ‖} .$$

The wireless communications device may correlate s_{ortho,c} with the received signal y according to Equation 4:

$${Corr}_{c} = {( {\overline{s}}_{o r t h o , c} )}^{H} y , \qquad ( 4 )$$

and may select the c*-th term candidate that provides maximum correlation (e.g., c*=argmax(abs(Corr_{c}))).

The wireless communications device may Update S̅_{ortho[1:n]} (e.g., S̅_{ortho[1:n]}=[S̅_{ortho[1:n-1]}, s̅_{ortho,c*}]) and may remove the c*-th term candidate from term candidates: Kₙ=Kₙ₋₁\{c*}. This process may be iterated until the quantity of terms (e.g., 11) has been selected.

In some cases, the wireless communications device may perform coefficient estimation at 340 to estimate coefficients for the terms of the NLIC model, including the selected inter-CC terms. The quantity of coefficients may be the same as a quantity of selected inter-CC terms. The wireless communications device may configure, or may be configured with, one or more time and/or frequency resources during which the wireless communications device may transmit a reference signal (e.g., the signal x[n]). The wireless communications device may use the reference signal to determine the interference value (e.g., the value of the SI 335) to be canceled. The wireless communications device may estimate the set of coefficients using information from the reference signal, such as using the signal itself. In some aspects, the wireless communications device may perform the coefficient estimation procedure using a least square algorithm, a recursive least square algorithm, or any other algorithm.

In some examples, at 345, the wireless communications device may perform interference reconstruction using the NLIC model, such as by using the estimated coefficients to reconstruct the SI portion. ŷ_{SI}[n], of the received signal, y[n]. At 350, the wireless communications device may obtain an SI canceled signal, y_{R}[n], by subtracting the self-interference reconstruction ŷ_{SI}[n] from the received signal y[n].

In some cases, the wireless communications device may perform the term selection procedure, the coefficient estimation procedure, or both periodically, semi-persistently, and/or aperiodically. In some aspects, the wireless communications device may perform the inter-CC term selection procedure concurrently while performing the coefficient estimation procedure. In some other aspects, the wireless communications device may perform the inter-CC term selection procedure prior to the coefficient estimation procedure.

FIG. 4 shows an example of an interference cancellation diagram 400 that supports multi-carrier NLIC for full-duplex communication in accordance with one or more aspects of the present disclosure. In some examples, the interference cancellation diagram 400 may implement or be implemented by the wireless communications system 100, the wireless communications system 200, and/or the interference cancellation diagram 300. For example, the interference cancellation diagram 400 may illustrate inter-CC term selection for NLIC of a CA signal and may be implemented by a wireless communications device (e.g., a wireless communications device 205 as described herein with reference to FIG. 2).

In some cases, the wireless communications device may concurrently transmit and receive signaling in a full-duplex communication mode, where the transmitted signaling is sent via multiple CCs (e.g., the CC1, CC2, CC3, and CC4). For example, a wireless communications device may transmit signaling in accordance with the transmission chain 405 and may concurrently receive signaling in accordance with the reception chain 410. The transmission may include a transmit signal 415-a sent using CC1, a transmit signal 415-b sent using CC2, a transmit signal 415-c sent using CC3, a transmit signal 415-d sent using CC4, and may also include additional transmit signals sent using any quantity of CCs. At 420, the wireless communications device may perform rotation and combining on the CA signal. Subsequently, at 425 and 430, respectively, the wireless communications device may clip the rotated and combined signal and then apply a DAC. At 435, the wireless communications device may apply a mixer and/or an upconverter prior to transmitting the CA signal via a transmit antenna 440.

At the receiver side, the wireless communications device may perform the operations of the reception chain 410, which may include cancelling an interference value from the transmitted CA signal. For example, the wireless communications device may receive the CA signal at a receive antenna 445. At 450 and 455, respectively, the wireless communications device may apply a mixer and/or downconverter, and then may perform rotation and splitting on the mixed and/or downconverter signal. Subsequently, the wireless communications device may perform NLIC on a per-CC basis, but using inter-CC terms. For example, at 460, the wireless communications device may perform NLIC for the transmit signal sent using CC4 independent from (e.g., at a different time than) the NLIC for the other CCs at 465.

The NLIC may include applying an ADC at 470 to convert the signal from the analog to the digital domain. The wireless communications device may store a term for the CC4 in a buffer at 475. Similarly, at 480, the wireless communications device may store one or more terms for other CCs. At 485, the wireless communications device may use the CC4 term and the other CC terms to construct an inter-CC term. In some cases, at 490, the wireless communications device may also use the buffered CC term (e.g., for CC4) to perform intra-CC term construction, and may subsequently perform intra-CC term selection at 495, which may include a similar process to the process for term selection, as described herein with reference to FIG. 3. At 496, the wireless communications device may perform coefficient estimation for the intra-CC terms and the inter-CC terms. The wireless communications device may use information from the CA transmit signal, or per CC transmit signals, and an algorithm to estimate the coefficients. The wireless communications device may store the estimated coefficients at a buffer. Subsequently, the wireless communications device may perform per-CC interference cancellation (e.g., SIC, NLIC, or both). Additionally, or alternatively, if the coefficients are already stored at a buffer, the wireless communications device may perform per-CC SIC at 497. For example, the wireless communications device may perform interference reconstruction using the NLIC model, such as by using the estimated coefficients to reconstruct the SI portion of the received signal. The wireless communications device may obtain an SI canceled signal by subtracting the self-interference reconstruction from the received signal.

At 498, the wireless communications device may obtain the desired decoded signal with canceled interference for the CC4. Similarly, at 499, the wireless communications device may obtain the desired decoded signal with canceled interference for the other CCs (e.g., with interference canceled for the transmit signal 415-a through the transmit signal 415-d).

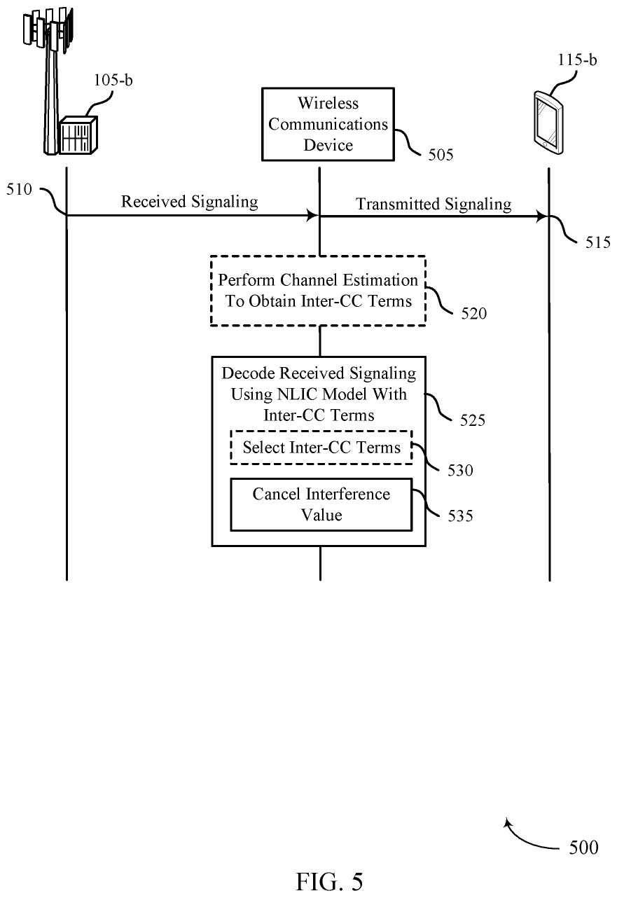

FIG. 5 shows an example of a process flow 500 that supports multi-carrier NLIC for full-duplex communication in accordance with one or more aspects of the present disclosure. In some examples, the process flow 500 may implement or be implemented by the wireless communication system 100, the wireless communication system 200, the interference cancellation diagram 300, and/or the interference cancellation diagram 400. For example, the process flow 500 may include a UE 115-b and a network entity 105-b, which may represent examples of corresponding devices described herein. Similarly, the process flow 500 may include a wireless communications device 505, which may be an example of a UE, a network entity, or a different wireless communications device. In this example, the wireless communications device 505 operating in a full-duplex mode may decode signaling based on cancelling an interference value caused by transmitted CA signaling on a per-CC basis, while accounting for inter-CC terms using a NLIC model.

In the following description of the process flow 500, the operations between the wireless communications device 505, the UE 115-b, and the network entity 105-b, may be performed in different orders or at different times. Some operations may also be left out of the process flow 500, or other operations may be added. Although the wireless communications device 505, the UE 115-b, and the network entity 105-b are shown performing the operations of the process flow 500, some aspects of some operations may also be performed by one or more other wireless devices.

At 510, the wireless communications device 505 may receive signaling using one or more time resources. The received signaling may have an interference value (e.g., a SI value from the signaling transmitted at 515). In some cases, the network entity 105-b may send the signaling using one or more CCs. The wireless communications device 505 may receive the signaling from the network entity 105-b, another UE, or any other wireless communications device.

At 515, the wireless communications device 505 may transmit signaling using one or more time resources that at least partially overlap with the time resources used for receiving the signaling at 510. That is, the transmitted signaling may at least partially overlap in the time domain with the received signaling in accordance with the wireless communications device 505 operating in a full-duplex operation mode. The wireless communications device 505 may transmit the signaling using multiple CCs. Thus, the transmitted signaling may be referred to as a CA signal. The wireless communications device 505 may send the signaling to a UE 115-b, a network entity, or any other wireless communications device.

At 520, the wireless communications device 505 may perform channel estimation on the transmitted signaling to obtain one or more inter-CC terms for a NLIC model. The transmitted signaling may include one or more reference signals.

At 525, the wireless communications device 505 may decode the received signaling in accordance with performing interference cancellation using an NLIC model with one or more inter-CC terms (e.g., kernels) for respective CCs of the transmitted CA signal. In some cases, the wireless communications device 525 may determine respective inter-CC terms for each CC.

In some cases, at 530, the wireless communications device 505 may select the inter-CC terms by comparing the respective inter-CC terms to one or more threshold values. Additionally, or alternatively, the wireless communications device 505 may select the inter-CC terms iteratively, as described herein with reference to FIG. 3. The wireless communications device may determine a quantity of inter-CC terms to select in accordance with an IMD-to-noise ratio for each CC, where the quantity of inter-CC terms increases or decreases, respectively, as the IMD-to-noise ratio increases or decreases.

At 535, the wireless communications device 505 may cancel the interference value using the NLIC model with the inter-CC terms. For example, the wireless communications device 505 may perform coefficient estimation at a first time to obtain one or more first coefficients for the one or more first inter-CC terms. The wireless communications device 505 may generate a SI reconstruction using the NLIC model and the first coefficients. In some cases, the wireless communications device 505 may store the first coefficients, the first inter-CC terms, or both in a buffer. The wireless communications device 505 may cancel the interference value from the received signal by subtracting the SI reconstruction from the received signal. At a later time (e.g., after a timer expires, or based on a configured or otherwise defined duration), the wireless communications device 505 may receive information for one or more second inter-CC terms at the buffer. The wireless communications device 505 may perform coefficient estimation to obtain one or more second coefficients for the one or more second inter-CC terms. The wireless communications device 505 may cancel the interference value by reconstructing the SI using the second coefficients and subtracting the reconstructed SI from the received signal.

In some cases, the wireless communications device 505 may perform SIC for each CC (e.g., on a per-CC basis) using the inter-CC terms. In some examples, the inter-CC terms include IMD values for the respective CCs, a gain for the respective CCs, one or more delay values for the respective CCs, or any combination thereof.

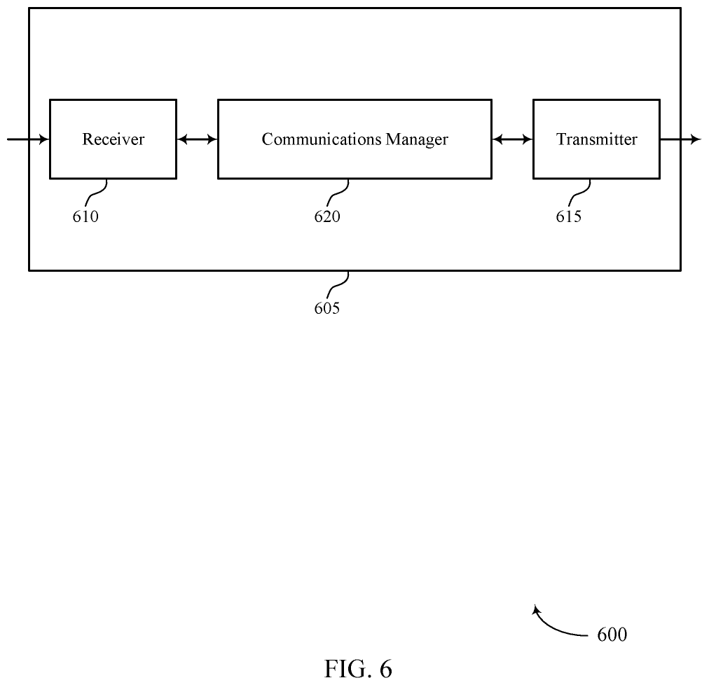

FIG. 6 shows a block diagram 600 of a device 605 that supports multi-carrier NLIC for full-duplex communication in accordance with one or more aspects of the present disclosure. The device 605 may be an example of aspects of a wireless communications device as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to multi-carrier NLIC for full-duplex communication). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to multi-carrier NLIC for full-duplex communication). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of multi-carrier NLIC for full-duplex communication as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a wireless communications device in accordance with examples as disclosed herein. For example, the communications manager 620 is capable of, configured to, or operable to support a means for transmitting, in accordance with a full-duplex operation mode at the wireless communications device, one or more first signals using a first set of multiple time resources, the one or more first signals associated with a set of multiple CCs. The communications manager 620 is capable of, configured to, or operable to support a means for receiving, using a second set of multiple time resources that at least partially overlap with the first set of multiple time resources, a second signal associated with an interference value corresponding to the one or more first signals. The communications manager 620 is capable of, configured to, or operable to support a means for decoding the second signal based on cancelling the interference value in accordance with a NLIC model including one or more first inter-CC terms corresponding to respective CCs of the set of multiple CCs.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for a wireless communications device operating in a full-duplex mode to decode signaling based on cancelling an interference value caused by transmitted CA signaling on a per-CC basis, while accounting for inter-CC terms using a NLIC model, which may provide for reduced processing, reduced power consumption, more efficient utilization of communication resources, and the like.

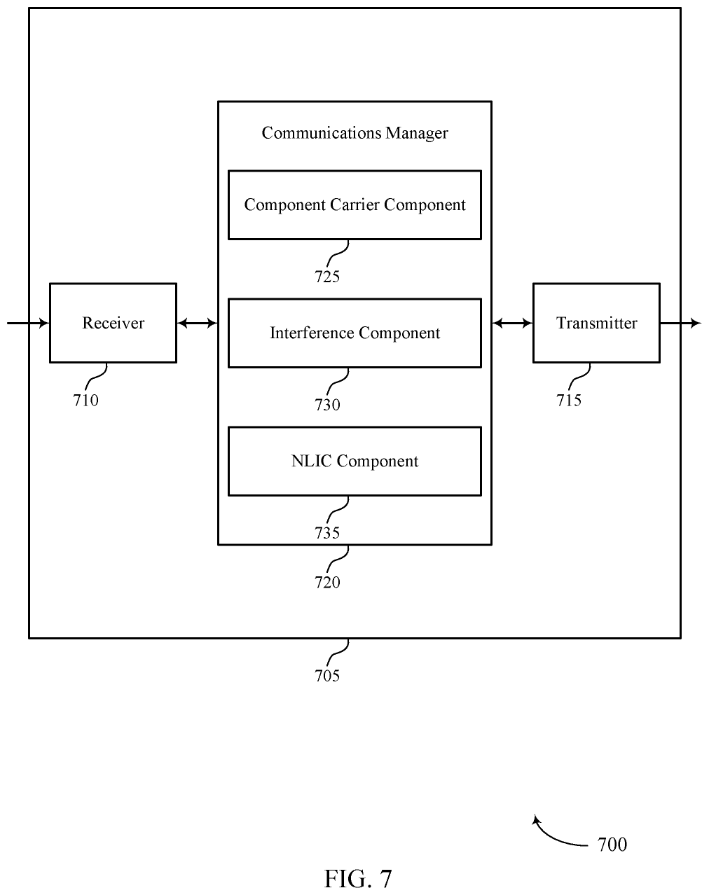

FIG. 7 shows a block diagram 700 of a device 705 that supports multi-carrier NLIC for full-duplex communication in accordance with one or more aspects of the present disclosure. The device 705 may be an example of aspects of a device 605 or a wireless communications device (e.g., a UE 115 or a network entity 105) as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to multi-carrier NLIC for full-duplex communication). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to multi-carrier NLIC for full-duplex communication). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of multi-carrier NLIC for full-duplex communication as described herein. For example, the communications manager 720 may include a CC component 725, an interference component 730, an NLIC component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a wireless communications device in accordance with examples as disclosed herein. The CC component 725 is capable of, configured to, or operable to support a means for transmitting, in accordance with a full-duplex operation mode at the wireless communications device, one or more first signals using a first set of multiple time resources, the one or more first signals associated with a set of multiple CCs. The interference component 730 is capable of, configured to, or operable to support a means for receiving, using a second set of multiple time resources that at least partially overlap with the first set of multiple time resources, a second signal associated with an interference value corresponding to the one or more first signals. The NLIC component 735 is capable of, configured to, or operable to support a means for decoding the second signal based on cancelling the interference value in accordance with a NLIC model including one or more first inter-CC terms corresponding to respective CCs of the set of multiple CCs.

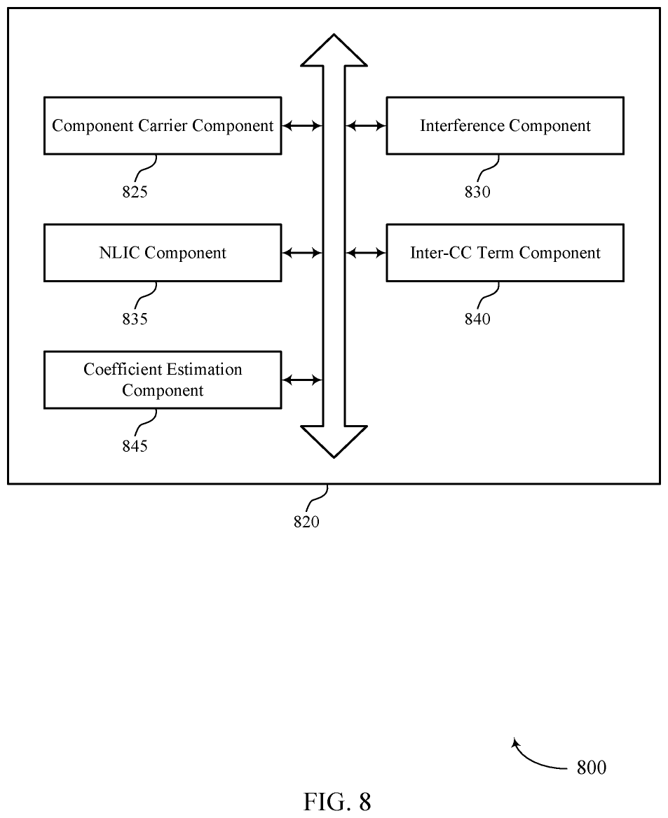

FIG. 8 shows a block diagram 800 of a communications manager 820 that supports multi-carrier NLIC for full-duplex communication in accordance with one or more aspects of the present disclosure. The communications manager 820 may be an example of aspects of a communications manager 620, a communications manager 720, or both, as described herein. The communications manager 820, or various components thereof, may be an example of means for performing various aspects of multi-carrier NLIC for full-duplex communication as described herein. For example, the communications manager 820 may include a CC component 825, an interference component 830, an NLIC component 835, an inter-CC term component 840, a coefficient estimation component 845, or any combination thereof. Each of these components may communicate, directly or indirectly, with one another (e.g., via one or more buses).

The communications manager 820 may support wireless communication at a wireless communications device in accordance with examples as disclosed herein. The CC component 825 is capable of, configured to, or operable to support a means for transmitting, in accordance with a full-duplex operation mode at the wireless communications device, one or more first signals using a first set of multiple time resources, the one or more first signals associated with a set of multiple CCs. The interference component 830 is capable of, configured to, or operable to support a means for receiving, using a second set of multiple time resources that at least partially overlap with the first set of multiple time resources, a second signal associated with an interference value corresponding to the one or more first signals. The NLIC component 835 is capable of, configured to, or operable to support a means for decoding the second signal based on cancelling the interference value in accordance with a NLIC model including one or more first inter-CC terms corresponding to respective CCs of the set of multiple CCs.

In some examples, the CC component 825 is capable of, configured to, or operable to support a means for determining, for each CC of the set of multiple CCs, respective inter-CC terms. In some examples, the inter-CC term component 840 is capable of, configured to, or operable to support a means for selecting, based on comparing the respective inter-CC terms to one or more threshold values, the one or more first inter-CC terms.

In some examples, the inter-CC term component 840 is capable of, configured to, or operable to support a means for determining a quantity of inter-CC terms to select based on an IMD-to-noise ratio for each CC of the set of multiple CCs.

In some examples, to support cancelling the interference value, the coefficient estimation component 845 is capable of, configured to, or operable to support a means for performing coefficient estimation to obtain one or more first coefficients for the one or more first inter-CC terms. In some examples, to support cancelling the interference value, the NLIC component 835 is capable of, configured to, or operable to support a means for generating, using the NLIC model, a SI reconstruction based on the one or more first coefficients, where cancelling the interference value includes subtracting the SI reconstruction from the second signal.

In some examples, the one or more first inter-CC terms are stored at a buffer of the wireless communications device, and the inter-CC term component 840 is capable of, configured to, or operable to support a means for receiving, at the buffer of the wireless communications device and based on a timer expiring, information corresponding to one or more second inter-CC terms. In some examples, the one or more first inter-CC terms are stored at a buffer of the wireless communications device, and the coefficient estimation component 845 is capable of, configured to, or operable to support a means for performing the coefficient estimation to obtain one or more second coefficients for the one or more second inter-CC terms, where the wireless communications device cancels the interference value in accordance with the one or more second coefficients.

In some examples, the inter-CC term component 840 is capable of, configured to, or operable to support a means for obtaining the one or more first inter-CC terms based on performing channel estimation using the one or more first signals.

In some examples, the one or more first inter-CC terms include one or more IMD values corresponding to the respective CCs, a gain corresponding to the respective CCs, one or more delay values corresponding to the respective CCs, or any combination thereof.

In some examples, to support cancelling the interference value, the interference component 830 is capable of, configured to, or operable to support a means for performing, for each CC of the respective CCs, SIC for the one or more first signals using the one or more first inter-CC terms.

In some examples, the second signal is associated with one or more CCs.

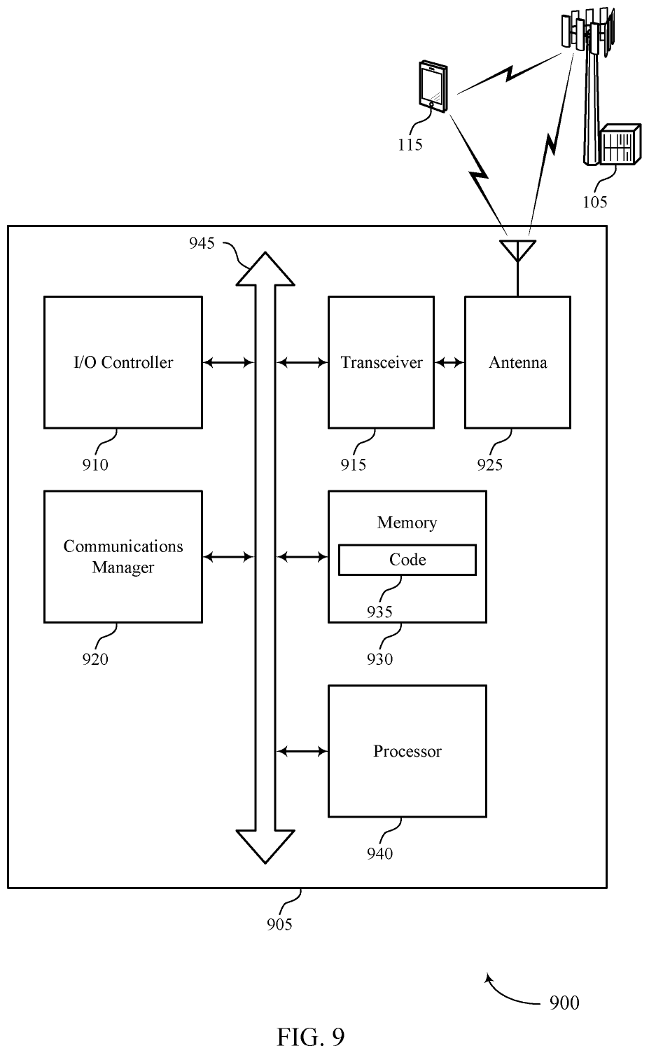

FIG. 9 shows a diagram of a system 900 including a device 905 that supports multi-carrier NLIC for full-duplex communication in accordance with one or more aspects of the present disclosure. The device 905 may be an example of or include the components of a device 605, a device 705, or a wireless communications device as described herein. The device 905 may include components for bi-directional voice and data communications including components for transmitting and receiving communications, such as a communications manager 920, an I/O controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include RAM and ROM. The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a BIOS which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting multi-carrier NLIC for full-duplex communication). For example, the device 905 or a component of the device 905 may include a processor 940 and memory 930 coupled with or to the processor 940, the processor 940 and memory 930 configured to perform various functions described herein.

The communications manager 920 may support wireless communication at a wireless communications device in accordance with examples as disclosed herein. For example, the communications manager 920 is capable of, configured to, or operable to support a means for transmitting, in accordance with a full-duplex operation mode at the wireless communications device, one or more first signals using a first set of multiple time resources, the one or more first signals associated with a set of multiple CCs. The communications manager 920 is capable of, configured to, or operable to support a means for receiving, using a second set of multiple time resources that at least partially overlap with the first set of multiple time resources, a second signal associated with an interference value corresponding to the one or more first signals. The communications manager 920 is capable of, configured to, or operable to support a means for decoding the second signal based on cancelling the interference value in accordance with a NLIC model including one or more first inter-CC terms corresponding to respective CCs of the set of multiple CCs.

By including or configuring the communications manager 920 in accordance with examples as described herein, the device 905 may support techniques for a wireless communications device operating in a full-duplex mode to decode signaling based on cancelling an interference value caused by transmitted CA signaling on a per-CC basis, while accounting for inter-CC terms using a NLIC model, which may provide for improved communication reliability, reduced latency, improved user experience related to reduced processing, reduced power consumption, more efficient utilization of communication resources, improved coordination between devices, longer battery life, improved utilization of processing capability, and the like.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described herein with reference to the communications manager 920 may be supported by or performed by the processor 940, the memory 930, the code 935, or any combination thereof. For example, the code 935 may include instructions executable by the processor 940 to cause the device 905 to perform various aspects of multi-carrier NLIC for full-duplex communication as described herein, or the processor 940 and the memory 930 may be otherwise configured to perform or support such operations.

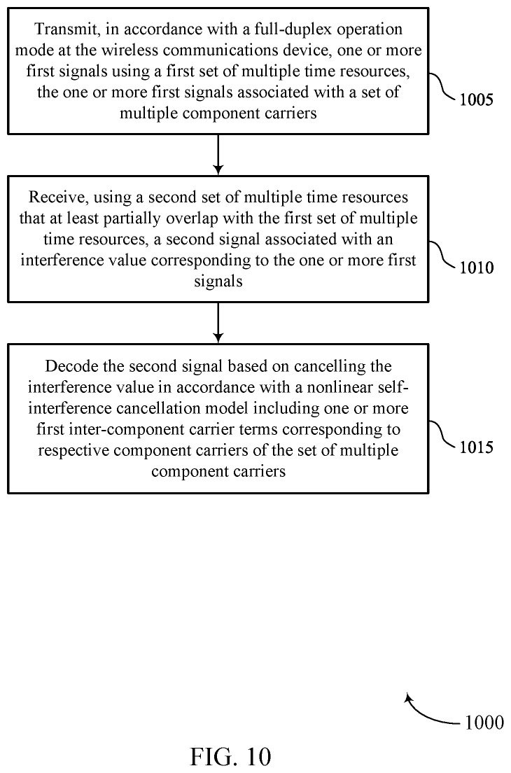

FIG. 10 shows a flowchart illustrating a method 1000 that supports multi-carrier NLIC for full-duplex communication in accordance with aspects of the present disclosure. The operations of the method 1000 may be implemented by a wireless communications device or its components as described herein. For example, the operations of the method 1000 may be performed by a wireless communications device as described herein with reference to FIGS. 1 through 9. In some examples, a wireless communications device may execute a set of instructions to control the functional elements of the wireless communications device to perform the described functions. Additionally, or alternatively, the wireless communications device may perform aspects of the described functions using special-purpose hardware.

At 1005, the method may include transmitting, in accordance with a full-duplex operation mode at the wireless communications device, one or more first signals using a first set of multiple time resources, the one or more first signals associated with a set of multiple CCs. The operations of 1005 may be performed in accordance with examples as disclosed herein. In some examples, aspects of the operations of 1005 may be performed by a CC component 825 as described herein with reference to FIG. 8.

At 1010, the method may include receiving, using a second set of multiple time resources that at least partially overlap with the first set of multiple time resources, a second signal associated with an interference value corresponding to the one or more first signals. The operations of 1010 may be performed in accordance with examples as disclosed herein. In some examples, aspects of the operations of 1010 may be performed by an interference component 830 as described herein with reference to FIG. 8.

At 1015, the method may include decoding the second signal based on cancelling the interference value in accordance with a NLIC model including one or more first inter-CC terms corresponding to respective CCs of the set of multiple CCs. The operations of 1015 may be performed in accordance with examples as disclosed herein. In some examples, aspects of the operations of 1015 may be performed by an NLIC component 835 as described herein with reference to FIG. 8.

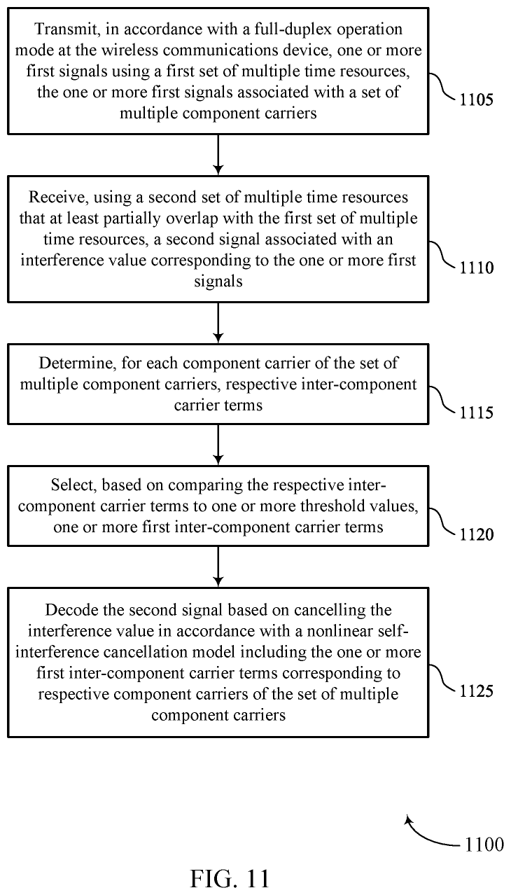

FIG. 11 shows a flowchart illustrating a method 1100 that supports multi-carrier NLIC for full-duplex communication in accordance with aspects of the present disclosure. The operations of the method 1100 may be implemented by a wireless communications device or its components as described herein. For example, the operations of the method 1100 may be performed by a wireless communications device as described herein with reference to FIGS. 1 through 9. In some examples, a wireless communications device may execute a set of instructions to control the functional elements of the wireless communications device to perform the described functions. Additionally, or alternatively, the wireless communications device may perform aspects of the described functions using special-purpose hardware.

At 1105, the method may include transmitting, in accordance with a full-duplex operation mode at the wireless communications device, one or more first signals using a first set of multiple time resources, the one or more first signals associated with a set of multiple CCs. The operations of 1105 may be performed in accordance with examples as disclosed herein. In some examples, aspects of the operations of 1105 may be performed by a CC component 825 as described herein with reference to FIG. 8.

At 1110, the method may include receiving, using a second set of multiple time resources that at least partially overlap with the first set of multiple time resources, a second signal associated with an interference value corresponding to the one or more first signals. The operations of 1110 may be performed in accordance with examples as disclosed herein. In some examples, aspects of the operations of 1110 may be performed by an interference component 830 as described herein with reference to FIG. 8.

At 1115, the method may include determining, for each CC of the set of multiple CCs, respective inter-CC terms. The operations of 1115 may be performed in accordance with examples as disclosed herein. In some examples, aspects of the operations of 1115 may be performed by a CC component 825 as described herein with reference to FIG. 8.

At 1120, the method may include selecting, based on comparing the respective inter-CC terms to one or more threshold values, one or more first inter-CC terms. The operations of 1120 may be performed in accordance with examples as disclosed herein. In some examples, aspects of the operations of 1120 may be performed by an inter-CC term component 840 as described herein with reference to FIG. 8.

At 1125, the method may include decoding the second signal based on cancelling the interference value in accordance with a NLIC model including the one or more first inter-CC terms corresponding to respective CCs of the set of multiple CCs. The operations of 1125 may be performed in accordance with examples as disclosed herein. In some examples, aspects of the operations of 1125 may be performed by an NLIC component 835 as described herein with reference to FIG. 8.

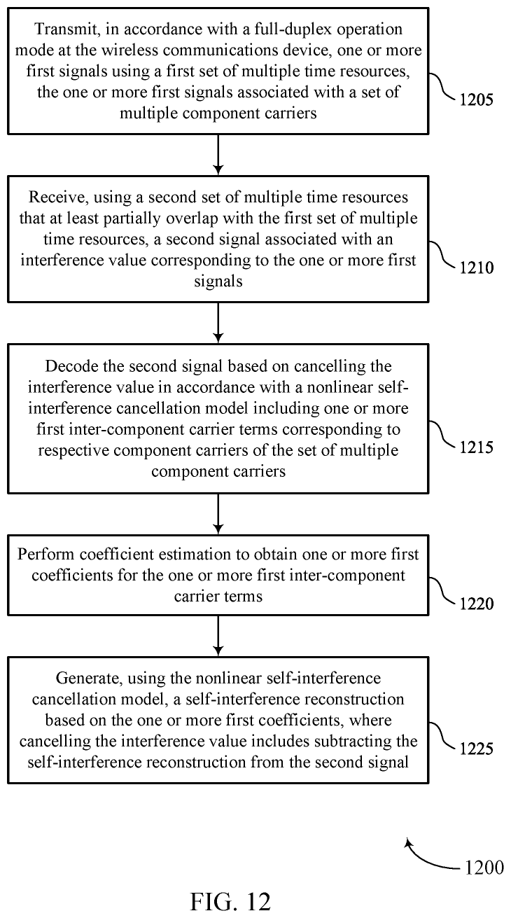

FIG. 12 shows a flowchart illustrating a method 1200 that supports multi-carrier NLIC for full-duplex communication in accordance with aspects of the present disclosure. The operations of the method 1200 may be implemented by a wireless communications device or its components as described herein. For example, the operations of the method 1200 may be performed by a wireless communications device as described herein with reference to FIGS. 1 through 9. In some examples, a wireless communications device may execute a set of instructions to control the functional elements of the wireless communications device to perform the described functions. Additionally, or alternatively, the wireless communications device may perform aspects of the described functions using special-purpose hardware.

At 1205, the method may include transmitting, in accordance with a full-duplex operation mode at the wireless communications device, one or more first signals using a first set of multiple time resources, the one or more first signals associated with a set of multiple CCs. The operations of 1205 may be performed in accordance with examples as disclosed herein. In some examples, aspects of the operations of 1205 may be performed by a CC component 825 as described herein with reference to FIG. 8.

At 1210, the method may include receiving, using a second set of multiple time resources that at least partially overlap with the first set of multiple time resources, a second signal associated with an interference value corresponding to the one or more first signals. The operations of 1210 may be performed in accordance with examples as disclosed herein. In some examples, aspects of the operations of 1210 may be performed by an interference component 830 as described herein with reference to FIG. 8.

At 1215, the method may include decoding the second signal based on cancelling the interference value in accordance with a NLIC model including one or more first inter-CC terms corresponding to respective CCs of the set of multiple CCs. The operations of 1215 may be performed in accordance with examples as disclosed herein. In some examples, aspects of the operations of 1215 may be performed by an NLIC component 835 as described herein with reference to FIG. 8.

At 1220, the method may include performing coefficient estimation to obtain one or more first coefficients for the one or more first inter-CC terms. The operations of 1220 may be performed in accordance with examples as disclosed herein. In some examples, aspects of the operations of 1220 may be performed by a coefficient estimation component 845 as described herein with reference to FIG. 8.

At 1225, the method may include generating, using the NLIC model, a SI reconstruction based on the one or more first coefficients, where cancelling the interference value includes subtracting the SI reconstruction from the second signal. The operations of 1225 may be performed in accordance with examples as disclosed herein. In some examples, aspects of the operations of 1225 may be performed by an NLIC component 835 as described herein with reference to FIG. 8.

The following provides an overview of aspects of the present disclosure:

Aspect 1: A method for wireless communication at a wireless communications device, comprising: transmitting, in accordance with a full-duplex operation mode at the wireless communications device, one or more first signals using a first plurality of time resources, the one or more first signals associated with a plurality of component carriers; receiving, using a second plurality of time resources that at least partially overlap with the first plurality of time resources, a second signal associated with an interference value corresponding to the one or more first signals; and decoding the second signal based at least in part on cancelling the interference value in accordance with a nonlinear self-interference cancellation model comprising one or more first inter-component carrier terms corresponding to respective component carriers of the plurality of component carriers.

Aspect 2: The method of aspect 1, further comprising: determining, for each component carrier of the plurality of component carriers, respective inter-component carrier terms; and selecting, based at least in part on comparing the respective inter-component carrier terms to one or more threshold values, the one or more first inter-component carrier terms.

Aspect 3: The method of aspect 2, further comprising: determining a quantity of inter-component carrier terms to select based at least in part on an intermodulation distortion (IMD)-to-noise ratio for each component carrier of the plurality of component carriers.

Aspect 4: The method of any of aspects 1 through 3, wherein cancelling the interference value comprises: performing coefficient estimation to obtain one or more first coefficients for the one or more first inter-component carrier terms; and generating, using the nonlinear self-interference cancellation model, a self-interference reconstruction based at least in part on the one or more first coefficients, wherein cancelling the interference value comprises subtracting the self-interference reconstruction from the second signal.

Aspect 5: The method of aspect 4, wherein the one or more first inter-component carrier terms are stored at a buffer of the wireless communications device, the method further comprising: receiving, at the buffer of the wireless communications device and based at least in part on a timer expiring, information corresponding to one or more second inter-component carrier terms; and performing the coefficient estimation to obtain one or more second coefficients for the one or more second inter-component carrier terms, wherein the wireless communications device cancels the interference value in accordance with the one or more second coefficients.

Aspect 6: The method of any of aspects 1 through 5, further comprising: obtaining the one or more first inter-component carrier terms based at least in part on performing channel estimation using the one or more first signals.

Aspect 7: The method of any of aspects 1 through 6, wherein the one or more first inter-component carrier terms comprise one or more intermodulation distortion (IMD) values corresponding to the respective component carriers, a gain corresponding to the respective component carriers, one or more delay values corresponding to the respective component carriers, or any combination thereof.

Aspect 8: The method of any of aspects 1 through 7, wherein cancelling the interference value comprises: performing, for each component carrier of the respective component carriers, self-interference cancellation for the one or more first signals using the one or more first inter-component carrier terms.

Aspect 9: The method of any of aspects 1 through 8, wherein the second signal is associated with one or more component carriers.

Aspect 10: An apparatus for wireless communication at a wireless communications device, comprising a processor; and a memory coupled with the processor, with instructions stored in the memory, the instructions executable by the processor to cause the apparatus to perform a method of any of aspects 1 through 9.

Aspect 11: An apparatus for wireless communication at a wireless communications device, comprising at least one means for performing a method of any of aspects 1 through 9.

Aspect 12: A non-transitory computer-readable medium storing code for wireless communication at a wireless communications device, the code comprising instructions executable by a processor to perform a method of any of aspects 1 through 9.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a wireless communications device, comprising:
a processor; and
memory coupled with the processor, with instructions stored in the memory, the instructions being executable by the processor to cause the apparatus to:
transmit, in accordance with a full-duplex operation mode at the wireless communications device, one or more first signals using a first plurality of time resources, the one or more first signals associated with a plurality of component carriers;
receive, using a second plurality of time resources that at least partially overlap with the first plurality of time resources, a second signal associated with an interference value corresponding to the one or more first signals; and
decode the second signal based at least in part on cancelling the interference value in accordance with a nonlinear self-interference cancellation model comprising one or more first inter-component carrier terms corresponding to respective component carriers of the plurality of component carriers.

2. The apparatus of claim 1, wherein the instructions are further executable by the processor to cause the apparatus to:
determine, for each component carrier of the plurality of component carriers, respective inter-component carrier terms; and
select, based at least in part on comparing the respective inter-component carrier terms to one or more threshold values, the one or more first inter-component carrier terms.

3. The apparatus of claim 2, wherein the instructions are further executable by the processor to cause the apparatus to:
determine a quantity of inter-component carrier terms to select based at least in part on an intermodulation distortion (IMD)-to-noise ratio for each component carrier of the plurality of component carriers.

4. The apparatus of claim 1, wherein the instructions to cancel the interference value are executable by the processor to cause the apparatus to:
perform coefficient estimation to obtain one or more first coefficients for the one or more first inter-component carrier terms; and
generate, using the nonlinear self-interference cancellation model, a self-interference reconstruction based at least in part on the one or more first coefficients, wherein cancelling the interference value comprises subtracting the self-interference reconstruction from the second signal.

5. The apparatus of claim 4, wherein the one or more first inter-component carrier terms are stored at a buffer of the wireless communications device, and the instructions are further executable by the processor to cause the apparatus to:
receive, at the buffer of the wireless communications device and based at least in part on a timer expiring, information corresponding to one or more second inter-component carrier terms; and
perform the coefficient estimation to obtain one or more second coefficients for the one or more second inter-component carrier terms, wherein the wireless communications device cancels the interference value in accordance with the one or more second coefficients.

6. The apparatus of claim 1, wherein the instructions are further executable by the processor to cause the apparatus to:
obtain the one or more first inter-component carrier terms based at least in part on performing channel estimation using the one or more first signals.

7. The apparatus of claim 1, wherein the one or more first inter-component carrier terms comprise one or more intermodulation distortion (IMD) values corresponding to the respective component carriers, a gain corresponding to the respective component carriers, one or more delay values corresponding to the respective component carriers, or any combination thereof.

8. The apparatus of claim 1, wherein the instructions to cancel the interference value are executable by the processor to cause the apparatus to:
perform, for each component carrier of the respective component carriers, self-interference cancellation for the one or more first signals using the one or more first inter-component carrier terms.

9. The apparatus of claim 1, wherein:
the second signal is associated with one or more component carriers.

10. A method for wireless communication at a wireless communications device, comprising:
transmitting, in accordance with a full-duplex operation mode at the wireless communications device, one or more first signals using a first plurality of time resources, the one or more first signals associated with a plurality of component carriers;
receiving, using a second plurality of time resources that at least partially overlap with the first plurality of time resources, a second signal associated with an interference value corresponding to the one or more first signals; and
decoding the second signal based at least in part on cancelling the interference value in accordance with a nonlinear self-interference cancellation model comprising one or more first inter-component carrier terms corresponding to respective component carriers of the plurality of component carriers.

11. The method of claim 10, further comprising:
determining, for each component carrier of the plurality of component carriers, respective inter-component carrier terms; and
selecting, based at least in part on comparing the respective inter-component carrier terms to one or more threshold values, the one or more first inter-component carrier terms.

12. The method of claim 11, further comprising:
determining a quantity of inter-component carrier terms to select based at least in part on an intermodulation distortion (IMD)-to-noise ratio for each component carrier of the plurality of component carriers.

13. The method of claim 10, wherein cancelling the interference value comprises:
performing coefficient estimation to obtain one or more first coefficients for the one or more first inter-component carrier terms; and
generating, using the nonlinear self-interference cancellation model, a self-interference reconstruction based at least in part on the one or more first coefficients, wherein cancelling the interference value comprises subtracting the self-interference reconstruction from the second signal.

14. The method of claim 13, wherein the one or more first inter-component carrier terms are stored at a buffer of the wireless communications device, the method further comprising:
receiving, at the buffer of the wireless communications device and based at least in part on a timer expiring, information corresponding to one or more second inter-component carrier terms; and
performing the coefficient estimation to obtain one or more second coefficients for the one or more second inter-component carrier terms, wherein the wireless communications device cancels the interference value in accordance with the one or more second coefficients.

15. The method of claim 10, further comprising:
obtaining the one or more first inter-component carrier terms based at least in part on performing channel estimation using the one or more first signals.

16. The method of claim 10, wherein the one or more first inter-component carrier terms comprise one or more intermodulation distortion (IMD) values corresponding to the respective component carriers, a gain corresponding to the respective component carriers, one or more delay values corresponding to the respective component carriers, or any combination thereof.

17. The method of claim 10, wherein cancelling the interference value comprises:
performing, for each component carrier of the respective component carriers, self-interference cancellation for the one or more first signals using the one or more first inter-component carrier terms.

18. The method of claim 10, wherein the second signal is associated with one or more component carriers.

19. An apparatus for wireless communication at a wireless communications device, comprising:
means for transmitting, in accordance with a full-duplex operation mode at the wireless communications device, one or more first signals using a first plurality of time resources, the one or more first signals associated with a plurality of component carriers;
means for receiving, using a second plurality of time resources that at least partially overlap with the first plurality of time resources, a second signal associated with an interference value corresponding to the one or more first signals; and
means for decoding the second signal based at least in part on cancelling the interference value in accordance with a nonlinear self-interference cancellation model comprising one or more first inter-component carrier terms corresponding to respective component carriers of the plurality of component carriers.

20. The apparatus of claim 19, further comprising:
means for determining, for each component carrier of the plurality of component carriers, respective inter-component carrier terms; and
means for selecting, based at least in part on comparing the respective inter-component carrier terms to one or more threshold values, the one or more first inter-component carrier terms.

21. The apparatus of claim 20, further comprising:
means for determining a quantity of inter-component carrier terms to select based at least in part on an intermodulation distortion (IMD)-to-noise ratio for each component carrier of the plurality of component carriers.

22. The apparatus of claim 19, the cancelling the interference value further comprising:
means for performing coefficient estimation to obtain one or more first coefficients for the one or more first inter-component carrier terms; and
means for generating, using the nonlinear self-interference cancellation model, a self-interference reconstruction based at least in part on the one or more first coefficients, wherein cancelling the interference value comprises subtracting the self-interference reconstruction from the second signal.

23. The apparatus of claim 22, wherein the one or more first inter-component carrier terms are stored at a buffer of the wireless communications device, the apparatus further comprising:
means for receiving, at the buffer of the wireless communications device and based at least in part on a timer expiring, information corresponding to one or more second inter-component carrier terms; and
means for performing the coefficient estimation to obtain one or more second coefficients for the one or more second inter-component carrier terms, wherein the wireless communications device cancels the interference value in accordance with the one or more second coefficients.

24. The apparatus of claim 19, further comprising:
means for obtaining the one or more first inter-component carrier terms based at least in part on performing channel estimation using the one or more first signals.

25. The apparatus of claim 19, wherein:
the one or more first inter-component carrier terms comprise one or more intermodulation distortion (IMD) values corresponding to the respective component carriers, a gain corresponding to the respective component carriers, one or more delay values corresponding to the respective component carriers, or any combination thereof.

26. The apparatus of claim 19, the cancelling the interference value further comprising:
means for performing, for each component carrier of the respective component carriers, self-interference cancellation for the one or more first signals using the one or more first inter-component carrier terms.

27. The apparatus of claim 19, wherein:
the second signal is associated with one or more component carriers.

28. A non-transitory computer-readable medium storing code for wireless communication at a wireless communications device, the code comprising instructions executable by a processor to:
transmit, in accordance with a full-duplex operation mode at the wireless communications device, one or more first signals using a first plurality of time resources, the one or more first signals associated with a plurality of component carriers;
receive, using a second plurality of time resources that at least partially overlap with the first plurality of time resources, a second signal associated with an interference value corresponding to the one or more first signals; and
decode the second signal based at least in part on cancelling the interference value in accordance with a nonlinear self-interference cancellation model comprising one or more first inter-component carrier terms corresponding to respective component carriers of the plurality of component carriers.

29. The non-transitory computer-readable medium of claim 28, wherein the instructions are further executable by the processor to:
determine, for each component carrier of the plurality of component carriers, respective inter-component carrier terms; and
select, based at least in part on comparing the respective inter-component carrier terms to one or more threshold values, the one or more first inter-component carrier terms.

30. The non-transitory computer-readable medium of claim 28, wherein the instructions to cancel the interference value are executable by the processor to:
perform coefficient estimation to obtain one or more first coefficients for the one or more first inter-component carrier terms; and
generate, using the nonlinear self-interference cancellation model, a self-interference reconstruction based at least in part on the one or more first coefficients, wherein cancelling the interference value comprises subtracting the self-interference reconstruction from the second signal.
